(19) United States
(12) Patent Application Publication
(10) Pub. No.: US 2011/0173101 A1
(43) Pub. Date: Jul. 14, 2011

(54) ORDERING METHOD AND SYSTEM

(76) Inventor: Otto Carl Gerntholtz, Cape Town (ZA)

(21) Appl. No.: 11/722,771

(22) PCT Filed: Feb. 5, 2007
(86) PCT No.: PCT/IB07/50374

§ 371 Date: Jun. 25, 2007

(51) Int. Cl. G06Q 30/00

(52) U.S. Cl. 705/27.2

(57) ABSTRACT

An ordering method for ordering and buying a product is provided which includes providing trademark selection means for a customer to select at least one selected trademark from a group of trademarks; reserving for the customer, for a specified period, at least one product with the selected trademark selected by the customer; and providing sale means to enable the customer to buy the product(s) selected.

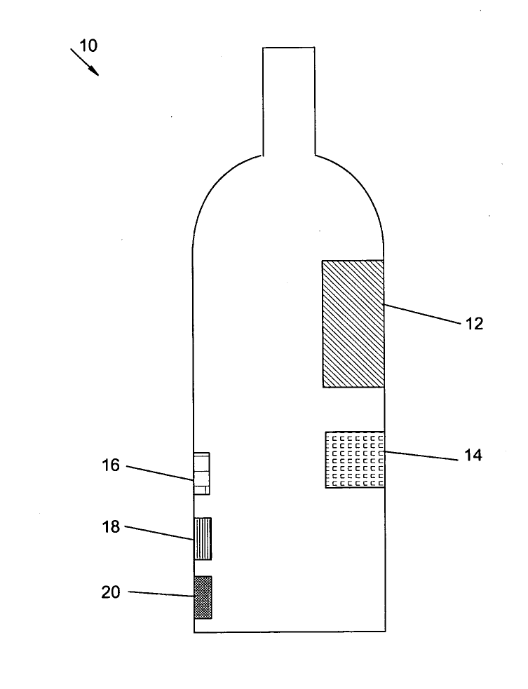

### FIELD OF INVENTION

The invention relates to an ordering method and system.

More particularly the invention relates to an ordering method and system for ordering and buying alcoholic beverages.

### BACKGROUND TO INVENTION

The market volume for alcoholic beverages in particular wines is enormous. These wines originate from all the corners of the globe, from European countries, such as France, Germany, Italy, Hungary, near East countries, the United States of America, and also from the so-called New World countries including South Africa, Argentina, Chile, New Zealand and Australia.

The millions of bottles of wines are branded under thousands of different trade marks. Some of these brands are present on millions of bottles per annum with only the indication of cultivar or vintage differing. Such wine brands include Goiya, Arniston Bay, KWV, Penfolds, Nederburg and Kumala.

The result is that generally exclusivity is not ensured. In other words, it is inevitable that when for dinner with friends a customer serves a wine bottle bearing a particular trade mark, a bottle with exactly the same trade mark is enjoyed during other dinners. Such non-exclusivity is problematic and disappointing.

Generally four different trade marks appear on a wine bottle, namely:
(a) the primary or main brand identifying the wine estate, e.g. Warwick in South Africa;
(b) the secondary or cultivar/blend brand identifying the cultivar/blend, e.g. Trilogy, the Warwick Bordeaux blend;
(c) the manufacturer's brand, e.g. Westcorp, Distell, KWV in South Africa; and
(d) the distributor's or importer's brand, e.g. Raison Social in the UK, and H&H in the United States.

As a rule the manufacturer's brand and the distributor's brand are inconspicuous, are printed in small lettering and are hidden somewhere on the wine bottle, normally on the rear side. The customers therefore focus primarily on the primary or main brand for quality and the secondary or cultivar/blend brand for type.

It is an object of the present invention to suggest an invention which will assist in overcoming the afore-mentioned problems.

### SUMMARY OF INVENTION

According to the invention, an ordering method for ordering and buying a product, includes the steps
(a) of providing trade mark selection means for a customer to select at least one selected trade mark from a group of trade marks;
(b) of reserving for the customer for a specified period at least one product with the selected trade mark selected by the customer; and
(c) of providing sale means to enable the customer to buy the product(s) selected.

The method may also include the further steps
(d) of providing at least one type of product for sale to customers, the product being branded with the selected trade mark(s); and
(e) of providing product selection means for the customer to select at least one type of product.

Also according to the invention, an ordering system for ordering and buying products, which includes
(a) trade mark selection means for a customer to select at least one selected trade mark selected from a group of trade marks;
(b) reserving means for reserving for the customer for a specified period at least one product with the selected trade mark(s) selected by the customer; and
(c) sale means to enable the customer to buy the product(s).

The system may also include
(d) provision means for providing at least one type of product for sale to the customers, the product being branded with the selected trade mark(s); and
(e) product selection means for the customer to select at least one type of product.

The step of reserving may include the step of limiting for a specified time period the sale of the products under the selected trade mark(s) selected by the customer.

The step of reserving may include the step of allowing the customer to buy the trade mark(s).

The method may be operable via a least one communication means selected from the group comprising the Internet, mobile communications means, a LAN, a WAN, electronic publications and printed communications.

The method may include credit card transaction means.

The credit card transaction means may be used for at least one function selected from the group comprising to confirm an order, to confirm a reservation, to pay for the products and to pay for the trade mark.

The method may be adapted to be operated by a manufacturer, a marketer, a licensor and/or an importer.

The trade mark(s) may be a registered trade mark(s).

The method may be operated by means of software.

The software may be written in at least one software selected from the group comprising html and flash design software.

The method may include interactive means, adapted to enable the customer to influence at least one component selected from the group comprising the trade mark(s), contents of the product(s), packaging of the product(s) and delivery of the product(s).

The specified period may be at least one selected from the group comprising three months, six months, twelve months, eighteen months, twenty four months, thirty six months, five years, ten years, fifteen years, twenty years, twenty five years, thirty years, and an indefinite period.

The method may include specification means whereby the customer is able to determine the specified period.

The specified period may be determined by the customer.

The specified period may be predetermined.

The specified period may be selected from a list of time periods.

The trade mark(s) may be a primary trade mark.

The trade mark(s) may be a secondary trade mark.

The product(s) may incorporate a sign of guarantee.

The guarantee may include at least one selected from the group comprising a certificate, a license agreement, a registered user agreement, a wax seal and a signature.

The method may include licensing means adapted to create a license agreement with the customer.

The license agreement may be for a limited period.

The license agreement may be for a limited territory.

The method may include the step of providing the customer with a guarantee of exclusivity.

The exclusivity may be at least one selected from the group comprising the limited sale of the selected trade mark for a specific period, a specific quantity, a specific alcoholic beverage, a specific cultivar, a specific vintage, and a specific territory.

The product may be an alcoholic beverage.

The alcoholic beverage may be at least one product selected from the group comprising a wine, a sparkling wine, a champagne, a liqueur, a distilled spirit, a fortified wine, a whisky, a brandy and a cognac.

The product selection means and the trade mark selection means may be integrated.

The trade mark may be at least one selected from the group comprising a logo, a word mark, a colour, a label, a bottle shape, a container shape, packaging, and get-up.

### BRIEF DESCRIPTION OF DRAWING

The invention shall now be described by way of example with reference to the accompanying drawing.

In the drawing there is shown a wine bottle depicting various brands.

### DETAILED DESCRIPTION OF INVENTION AND DRAWING

The drawing shows a wine bottle 10 provided with five different trade marks, namely:
(a) the primary or main brand 12 identifying the wine estate, e.g. Warwick in South Africa;
(b) the secondary or cultivar/blend brand 14 identifying the cultivar/blend, e.g. Trilogy, the Warwick Bordeaux blend;
(c) the manufacturer's brand 16, e.g. Westcorp, Distell, KWV in South Africa;
(d) the distributor's brand 18, e.g. Nuced and Louis Wine Distributors in South Africa; and
(3) the importer's brand 20, e.g. Raison Social in the UK, and H&H in the United States.

Other information as required may also appear on the bottle, such as the alcohol percentage, a health warning in terms of health regulations, and the volume.

In one example, the ordering system for ordering alcoholic beverages in accordance with the invention, includes
(a) a list of products for sale, which includes at least one product branded by at least one trade mark to at least one customer;
(b) selection means for the customer to select at least one product from the list of product;
(c) limited means for limiting the sale of the specific product selected by the customer for a limited period; and
(d) sale means to enable the customer to buy the product selected.

The invention thus provides an ordering method for ordering alcoholic beverages, including the following steps
(a) of providing a list of products for sale, which includes at least one product branded by at least one trade mark to at least one customer;
(b) of providing selection means for the customer to select at least one product from the list of product;
(c) of limiting the sale of the specific product selected by the customer for a limited period; and
(d) of providing sale means to enable the customer to buy the product selected.

The ordering method is generally provided by a manufacturer, a marketer, a licensor or an importer.

The trade mark is generally a registered trade mark. The trade mark can be a primary trade mark and/or a secondary trade mark.

The ordering method is provided via or over the Internet, ut can also be adapted to operate via mobile communications, a LAN, a WAN, electronic publications and printed publications.

The ordering method includes credit card transaction means.

The ordering method includes software, which can be written in html and flash design software.

The ordering method includes interactive means, whereby the customer influences the trade mark, the contents of the product and the packaging of the product.

The limited period is three, six, twelve or twenty four months and can be determined by the customers. The limited period can be predetermined and be selected from a list of periods.

The product incorporates a sign of guarantee, which includes a certificate, a license agreement, a registered user agreement, a wax seal or a signature.

The license agreement is for a limited period, a limited territory and be between the customer and the manufacturer, the marketer, the licensor or the importer.

The guarantee thus confirms an exclusivity, which is selected from the group comprising the limited sale of the selected trade mark for
(a) a specific period;
(b) a specific quantity;
(c) a specific alcoholic beverage;
(d) a specific cultivar;
(e) a specific vintage; and
(f) a specific territory.

The alcoholic beverage is at least one product selected from the group comprising a wine, a sparkling wine, a champagne, a liqueur, a distilled spirit, a fortified wine, a whisky, a brandy and a cognac.

1. An ordering method for ordering and buying a product, which includes the steps
(a) of providing trade mark selection means for a customer to select at least one selected trade mark from a group of trade marks;
(b) of reserving for the customer for a specified period at least one product with the selected trade mark selected by the customer; and
(c) of providing sale means to enable the customer to buy the product(s) selected.

2. A method as claimed in claim 1, which includes the further steps
(d) of providing at least one type of product for sale to customers, the product being branded with the selected trade mark(s); and
(e) of providing product selection means for the customer to select at least one type of product.

3. A method as claimed in claim 1 or claim 2, in which the step of reserving includes the step of limiting for a specified time period the sale of the products under the selected trade mark(s) selected by the customer.

4. A method as claimed in any one of the preceding claims, in which the step of reserving includes the step of allowing the customer to buy the trade mark(s).

5. A method as claimed in any one of the preceding claims, which is operable via a least one communication means selected from the group comprising the Internet, mobile communications means, a LAN, a WAN, electronic publications and printed communications.

6. A method as claimed in any one of the preceding claims, which includes credit card transaction means.

7. A method as claimed in claim 6, in which the credit card transaction means is used for at least one function selected from the group comprising to confirm an order, to confirm a reservation, to pay for the products and to pay for the trade mark.

8. A method as claimed in any one of the preceding claims, which is adapted to be operated by a manufacturer, a marketer, a licensor and/or an importer.

9. A method as claimed in any one of the preceding claims, in which the trade mark(s) is (are) a registered trade mark(s).

10. A method as claimed in any one of the preceding claims, which is operated by means of software.

11. A method as claimed in claim 10, in which the software is written in at least one software selected from the group comprising html and flash design software.

12. A method as claimed in any one of the preceding claims, which includes interactive means, adapted to enable the customer to influence at least one component selected from the group comprising the trade mark(s), contents of the product(s), packaging of the product(s) and delivery of the product(s).

13. A method as claimed in any one of the preceding claims, in which the specified period is at least one selected from the group comprising three months, six months, twelve months, eighteen months, twenty four months, thirty six months, five years, ten years, fifteen years, twenty years, twenty five years, thirty years, and an indefinite period.

14. A method as claimed in any one of the preceding claims, which includes specification means whereby the customer is able to determine the specified period.

15. A method as claimed in any one of the preceding claims, in which the specified period is determined by the customer.

16. A method as claimed in any one of claims 1 to 13, in which the specified period is predetermined.

17. A method as claimed in any one of the preceding claims, in which the specified period is selected from a list of time periods.

18. A method as claimed in any one of the preceding claims, in which the trade mark(s) is a primary trade mark.

19. A method as claimed in any one of the preceding claims, in which the trade mark(s) is a secondary trade mark.

20. A method as claimed in any one of the preceding claims, in which the product(s) incorporates a sign of guarantee.

21. A method as claimed in claim 20, in which the guarantee include at least one selected from the group comprising a certificate, a license agreement, a registered user agreement, a wax seal and a signature.

22. A method as claimed in any one of the preceding claims, which include licensing means adapted to create a license agreement with the customer.

23. A method as claimed in claim 22, in which the license agreement is for a limited period.

24. A method as claimed in claim 22 or claim 23, in which the license agreement is for a limited territory.

25. A method as claimed in any one of the preceding claims, which includes the step of providing the customer with a guarantee of exclusivity.

26. A method as claimed in claim 25, in which the exclusivity is at least one selected from the group comprising the limited sale of the selected trade mark for a specific period, a specific quantity, a specific alcoholic beverage, a specific cultivar, a specific vintage, and a specific territory.

27. A method as claimed in any one of the preceding claims, in which the product is an alcoholic beverage.

28. A method as claimed in any one of the preceding claims, in which the alcoholic beverage is at least one product selected from the group comprising a wine, a sparkling wine, a champagne, a liqueur, a distilled spirit, a fortified wine, a whisky, a brandy and a cognac.

29. A method as claimed in any one of the preceding claims, in which the product selection means and the trade mark selection means are integrated.

30. A method as claimed in any one of the preceding claims, in which the trade mark is at least one selected from the group comprising a logo, a word mark, a colour, a label, a bottle shape, a container shape, packaging, and get-up.

31. An ordering system for ordering and buying products, which includes
(a) trade mark selection means for a customer to select at least one selected trade mark selected from a group of trade marks;
(b) reserving means for reserving for the customer for a specified period at least one product with the selected trade mark(s) selected by the customer; and
(c) sale means to enable the customer to buy the product(s).

32. A system as claimed in claim 30, which includes
(d) provision means for providing at least one type of product for sale to the customers, the product being branded with the selected trade mark(s); and
(e) product selection means for the customer to select at least one type of product.

33. A system as claimed in claim 31 or 32, in which the reserving means includes limiting means for limiting for a specified time period the sale of the products under the selected trade mark(s) selected by the customer.

34. A system as claimed in any one of claims 31 to 33, in which the reserving means is adapted to allow the customer the buy the trade mark(s).

35. A system as claimed in any one of claims 31 to 34, in which the product(s) is (are) an alcoholic beverage.

36. An ordering method for ordering and buying products substantially as hereinbefore described.

37. An ordering system for ordering and buying products substantially as hereinbefore described.

38. An ordering method for ordering and buying alcoholic beverages substantially as hereinbefore described.

39. An ordering system for ordering and buying alcoholic beverages substantially as hereinbefore described.
